(19) United States
(12) Patent Application Publication
(10) Pub. No.: US 2023/0405898 A1
(43) Pub. Date: Dec. 21, 2023

(54) DIE CLAMPING DEVICE FOR INJECTION MOLDING MACHINE

(71) Applicant: FANUC CORPORATION, Minamitsuru-gun, Yamanashi (JP)

(72) Inventors: Tatsuhiro UCHIYAMA, Minamitsuru-gun, Yamanashi-ken (JP); Naruhiro NISHIMURA, Minamitsuru-gun, Yamanashi-ken (JP); Masatoshi SENGA, Minamitsuru-gun, Yamanashi-ken (JP)

(73) Assignee: FANUC CORPORATION, Minamitsuru-gun, Yamanashi (JP)

(21) Appl. No.: 18/035,777

(22) PCT Filed: Nov. 8, 2021
(86) PCT No.: PCT/JP2021/040906

§ 371 Date: May 8, 2023

(30) Foreign Application Priority Data
Nov. 13, 2020 (JP) 2020-189415

(51) Int. Cl. B29C 45/66

(52) U.S. Cl. CPC B29C 45/66; B22D 17/26

(57) ABSTRACT

A die clamping device for an injection molding machine comprises: a ball screw that is rotated by a motor; a crosshead that is disposed between a rear platen and a movable platen and moves along the axial direction of a tie-bar via the rotation of the ball screw; a toggle link that moves along the axial direction of the movable platen in accordance with the movement of the crosshead; and a crosshead pressing mechanism that presses the crosshead such that the crosshead moves toward the rear platen side.

### TECHNICAL FIELD

The present invention relates to a mold clamping device of (die clamping device for) an injection molding machine.

### BACKGROUND ART

The injection molding machine includes a mold clamping device that opens and closes a mold (a fixed mold and a movable mold). The mold clamping device generates a clamping force by extending a toggle mechanism (toggle links or the like) by a drive mechanism, for example. Here, in order to suppress energy consumption of the drive mechanism, it is desirable that the toggle mechanism is completely extended when the clamping force is generated. However, if the completely extended state continues for a long time, the toggle mechanism may be stuck due to oil film breakage or the like. As a result, the mold clamping device becomes inoperable. JP H11-198202 A discloses, as a countermeasure against this problem, a technique of moving the movable platen more backward than the mold touch position before stopping the mold clamping device.

### SUMMARY OF THE INVENTION

However, there is a problem in that, due to power failure, malfunction, or the like, the drive mechanism becomes inoperable, and as a result, the movable platen cannot be moved backward. Therefore, it is preferable that the extended state of the toggle mechanism can be released by moving the movable platen backward even if the drive mechanism becomes inoperable.

The present invention has the object of solving the aforementioned problem.

According to an aspect of the present invention, there is provided a mold clamping device of an injection molding machine, the mold clamping device comprising: a stationary platen configured to hold a fixed mold; a rear platen; a plurality of tie bars configured to connect the stationary platen and the rear platen; a movable platen disposed between the stationary platen and the rear platen, and configured to hold a movable mold in a manner so that the movable mold and the fixed mold face each other, the movable platen being movable along an axial direction of each of the tie bars; a ball screw configured to be rotated by a motor; a crosshead disposed between the rear platen and the movable platen, and configured to be moved along the axial direction by rotation of the ball screw; a toggle link configured to move the movable platen along the axial direction in accordance with movement of the crosshead; and a crosshead pressing mechanism configured to press the crosshead in order for the crosshead to move toward the rear platen.

According to the present invention, it is possible to provide a mold clamping device of an injection molding machine that is capable of releasing the extended state of a toggle mechanism even if a drive mechanism for driving the toggle mechanism becomes inoperable.

### BRIEF DESCRIPTION OF DRAWINGS

FIG. 1 is a view showing an injection molding machine according to an embodiment;

FIG. 2 is a perspective view showing a state in which a crosshead is viewed from a movable platen in the injection molding machine according to the embodiment;

FIG. 3 is a top view showing a state in which the crosshead is viewed from an upper toggle link in the injection molding machine according to the embodiment;

FIG. 4 is a top view showing a state in which the crosshead is viewed from the upper toggle link in the injection molding machine according to a first modification;

FIG. 5 is a top view showing a state in which the crosshead is viewed from the upper toggle link in the injection molding machine according to a second modification; and

FIG. 6 is a top view showing a state in which the crosshead is viewed from the upper toggle link in the injection molding machine according to a third modification.

### DETAILED DESCRIPTION OF THE INVENTION

Hereinafter, a mold clamping device of an injection molding machine according to an embodiment will be described in detail.

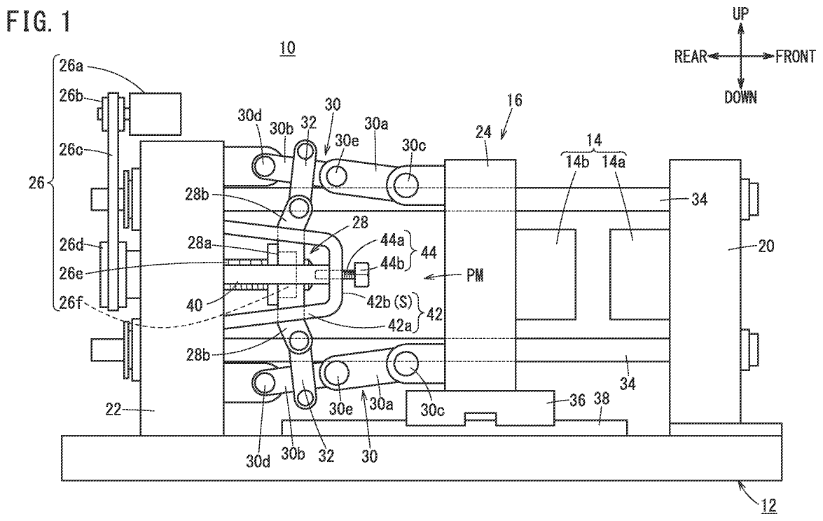

FIG. 1 is a view showing an injection molding machine 10 according to the embodiment. The injection molding machine 10 includes a base 12, a mold clamping device 16 that opens and closes a mold 14, and an injection device (not shown) that injects melted resin into the mold 14. In FIG. 1, an up-down direction and a front-rear direction are shown.

The base 12 serves as a base for installing the mold clamping device 16 and the injection device thereon. The mold clamping device 16 includes a stationary platen 20, a rear platen 22, a movable platen 24, a drive mechanism 26, a crosshead 28, toggle links 30, and crosshead links 32.

The stationary platen 20 and the rear platen 22 are disposed on the base 12 and connected to each other by four tie bars 34. The four tie bars 34 extend parallel to each other in the front-rear direction and pass through the movable platen 24. The front-rear direction is an axial direction of the four tie bars 34. The movable platen 24 is installed on the base 12 via a slide portion 36, between the stationary platen 20 and the rear platen 22. A guide rail 38 is provided on the base 12 to extend in the front-rear direction. The slide portion 36 is movable along the guide rail 38. Thus, the movable platen 24 can move forward and backward in the front-rear direction with respect to the stationary platen 20. The four tie bars 34 function as guide members and clamping force generating members. The guide member guides movement of the movable platen 24 in the front-rear direction. The clamping force generating member generates a predetermined clamping force in the mold 14 by a reaction force when the toggle links 30 are extended.

The mold 14 is provided between the stationary platen 20 and the movable platen 24. The mold 14 includes a fixed mold 14a and a movable mold 14b. The fixed mold 14a is attached to the surface of the stationary platen 20 that faces the movable platen 24. The movable mold 14b is attached to the surface of the movable platen 24 that faces the stationary platen 20.

The drive mechanism 26 moves the crosshead 28 forward and backward in the front-rear direction. The drive mechanism 26 includes a mold opening/closing motor 26a (drive source), a drive pulley 26b, a belt 26c, a driven pulley 26d, a ball screw 26e, and a nut 26f.

The drive pulley 26b is rotatable integrally with the rotary shaft of the mold opening/closing motor 26a. The driven pulley 26d is rotatable integrally with the ball screw 26e. The belt 26c is wound around the drive pulley 26b and the driven pulley 26d. The belt 26c transmits the rotational force of the drive pulley 26b to the driven pulley 26d. The ball screw 26e extends in the front-rear direction so as to be parallel with the axis of the tie bar 34. The nut 26f is fixed to the crosshead 28 and is screwed with the ball screw 26e.

The mold opening/closing motor 26a rotates the ball screw 26e via the drive pulley 26b, the belt 26c, and the driven pulley 26d. When the ball screw 26e rotates relative to the nut 26f, the nut 26f moves forward and backward in the front-rear direction along the ball screw 26e. As a result, as the ball screw 26e rotates, the crosshead 28 moves forward and backward in the front-rear direction together with the nut 26f.

In this instance, the nut 26f is moved forward and backward by rotating the ball screw 26e, but the arrangement and roles of the ball screw 26e and the nut 26f may be reversed as described below. First, the nut 26f is rotated by the mold opening/closing motor 26a. With the rotation of the nut 26f, the ball screw 26e screwed with the nut 26f is moved forward and backward. As a result, the crosshead 28 can be moved forward and backward. In any case, the crosshead 28 moves along the front-rear direction by (relative) rotation of the ball screw 26e with respect to the nut 26f.

In order to stabilize the forward and backward movement of the crosshead 28, the crosshead 28 is guided by guide rods 40 extending in the front-rear direction. The guide rods 40 are held by guide rod supports 42 provided on the rear platen 22.

Two toggle links 30 and two crosshead links 32 are provided on the upper side. Two toggle links 30 and two crosshead links 32 are also provided on the lower side. That is, a total of four toggle links 30 and a total of four crosshead links 32 are provided. Here, two toggle links 30 and two crosshead links 32 are shown on the upper and lower sides of the front side of the plane of the figure. Two toggle links 30 and two crosshead links 32 on the back side of the plane of the figure are hidden. Each of the toggle links 30 includes a first link rod 30a, a second link rod 30b, a first toggle pin 30c, a second toggle pin 30d, and a third toggle pin 30e.

One end of the first link rod 30a is pivotably connected to the movable platen 24 through the first toggle pin 30c. One end of the second link rod 30b is pivotably connected to the rear platen 22 through the second toggle pin 30d. The other end of the first link rod 30a and the other end of the second link rod 30b are pivotably connected to each other through the third toggle pin 30e. The second link rods 30b are each connected to the crosshead 28 through the crosshead link 32.

The toggle links 30 are each connected to the crosshead 28 through the crosshead link 32. The toggle links 30 are extended or bent in response to the forward and backward movement of the crosshead 28 in the front-rear direction, whereby the toggle links 30 move the movable platen 24 forward and backward in the front-rear direction. The toggle links 30 and the crosshead links 32 form a toggle mechanism for increasing the driving force of the crosshead 28 in the front-rear direction and transmitting the increased driving force to the movable platen 24. As the crosshead 28 moves forward, the toggle links 30 are extended. As a result, the movable platen 24 moves forward. Conversely, as the crosshead 28 moves rearward, the toggle links 30 are bent and contracted. As a result, the movable platen 24 moves backward. It should be noted that, in a state where the toggle links 30 are fully extended, the clamping force of the mold 14 is maintained even if the forward movement of the crosshead 28 by the mold opening/closing motor 26a is stopped.

As described above, by rotating the ball screw 26e using the mold opening/closing motor 26a, the crosshead 28 moves forward and backward. As the crosshead 28 moves forward and backward, the toggle links 30 are extended or bent. As a result, the movable platen 24 is moved forward and backward, and the mold 14 is opened and closed in the front-rear direction.

The mold clamping device 16 includes a crosshead pressing mechanism PM. The crosshead pressing mechanism PM presses the crosshead 28 in order for the crosshead 28 to move toward the rear platen 22. As described above, if a state in which the toggle mechanism (the toggle links 30 and the crosshead links 32) is completely extended continues for a long time, the toggle mechanism may be stuck due to oil film breakage or the like. As a result, the mold clamping device 16 becomes inoperable. The crosshead pressing mechanism PM is a mechanism for releasing the extended state of the toggle mechanism without using the mold opening/closing motor 26a. The oil film breakage refers to a state in which an oil film (film of lubrication oil) formed between sliding members is lost. That is, the sliding members are in direct contact with each other. Between the sliding members refers to, for example, between the first link rod 30a and the first toggle pin 30c. When the toggle mechanism is fully extended, for example, the oil film between the first link rod 30a and the first toggle pin 30c is pushed out by the pressure, and thus oil film breakage is likely to occur.

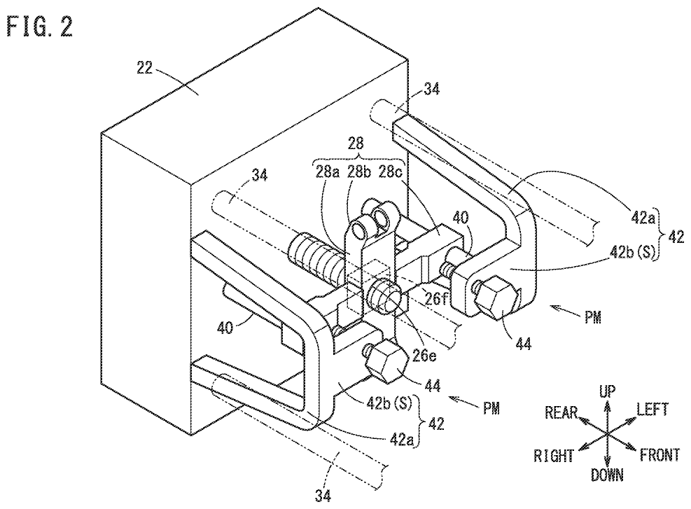

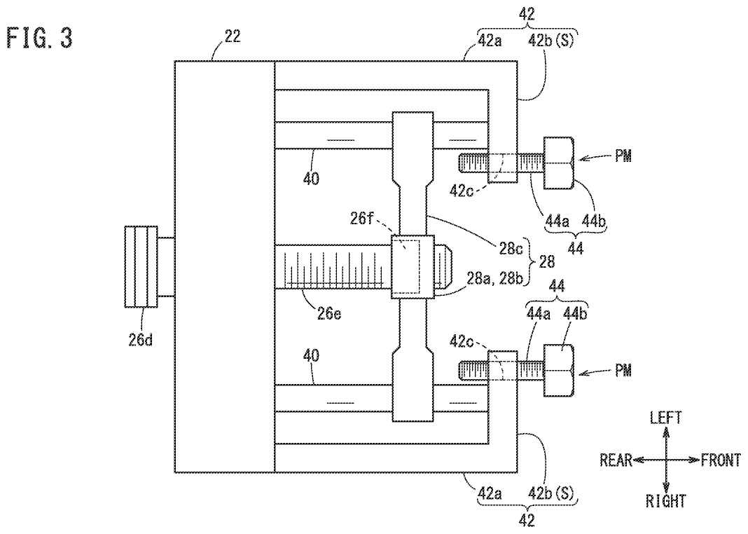

Details of the crosshead 28, the guide rod 40, and the crosshead pressing mechanism PM will be described below. FIG. 2 is a perspective view showing a state in which the crosshead 28 is viewed from the movable platen 24 in the injection molding machine 10 according to the embodiment. FIG. 3 is a top view showing a state in which the crosshead 28 is viewed from the upper toggle link 30 in the injection molding machine 10 according to the embodiment. In FIG. 2, the tie bars 34 are represented not by solid lines but by imaginary lines for ease of understanding. The following description will be made basically based on FIG. 3.

The crosshead 28 includes a central portion 28a, two arms 28b extending upward and downward, respectively, from the central portion 28a, and two arms 28c extending leftward and rightward, respectively, from the central portion 28a. The crosshead link 32 is connected to the arm 28b, but illustration of the crosshead link 32 is omitted in FIGS. 2 and 3 for ease of understanding. Two guide rods 40 are inserted into the two arms 28c, respectively. That is, the crosshead 28 is movable forward and backward in the front-rear direction while being guided by the two guide rods 40 extending in the front-rear direction.

The two guide rods 40 are disposed on the left and right sides of the ball screw 26e, respectively. The two guide rods 40 extend in the front-rear direction. Rear end portions of the two guide rods 40 are supported by the rear platen 22. Front end portions of the two guide rods 40 are supported by two guide rod supports 42, respectively. The two guide rod supports 42 are substantially U-shaped. Each of the two guide rod supports 42 includes two base portions 42a and a support portion 42b. The two base portions 42a are fixed to the front surface of the rear platen 22 and protrude forward. The support portion 42b is provided at front end portions of the two base portions 42a. The support portion 42b supports the guide rod 40.

The mold clamping device 16 includes two crosshead pressing mechanisms PM. Each of the two crosshead pressing mechanisms PM includes a screw member 44, and a support member S that is screwed with the screw member 44 to support the screw member 44. In the present embodiment, the support portion 42b of the guide rod support 42 functions as the support member S. Therefore, the support portion 42b includes an internal threaded portion (screw hole) 42c that is screwed with the screw member 44.

The screw member 44 has a shape extending along the front-rear direction, and includes an external threaded portion 44a and a head portion 44b. The external threaded portion 44a is screwed with the internal threaded portion 42c of the support member S (the support portion 42b). The head portion 44b is fixed to an end portion of the external threaded portion 44a to rotate the external threaded portion 44a. The head portion 44b is rotated with respect to the support portion 42b by means of a wrench or the like which grips the head portion 44b.

Accordingly, the screw member 44 moves backward with respect to the support portion 42b. As a result, the screw member 44 presses the crosshead 28, and the crosshead 28 moves backward.

In this manner, even when the mold opening/closing motor 26a fails or a power failure occurs, the crosshead 28 can be moved backward by rotating the screw member 44. As a result, the extended state (for example, the lock-up state) of the toggle mechanism can be released. The lock-up state refers to a state in which the toggle link 30 is extended by a predetermined amount or more, and as a result, a clamping force is generated between the fixed mold 14a and the movable mold 14b. The clamping force is released by releasing the extended state of the toggle mechanism. As a result, it is possible to prevent the toggle mechanism from being stuck due to oil film breakage or the like of the toggle mechanism. The screw member 44 of the crosshead pressing mechanism PM can output a force (axial force) required to release the lock-up state. In general, when the clamping force is generated, the friction between the sliding members in the toggle link 30 increases. Meanwhile, a large torque is applied by a tool to the screw member 44 of the crosshead pressing mechanism PM. As a result, a force (axial force) required to release the lock-up state against the friction in the toggle link 30 is output from the screw member 44 to the crosshead 28.

Here, the two crosshead pressing mechanisms PM (the screw members 44 and the support members S) are arranged symmetrically with respect to the ball screw 26e in the width direction of the mold clamping device 16 (the left-right direction) which is orthogonal to the front-rear direction. As a result, pressing forces that are symmetrical in the width direction are applied to the crosshead 28 from the two crosshead pressing mechanisms PM. This facilitates the movement of the crosshead 28.

### (Modification 1)

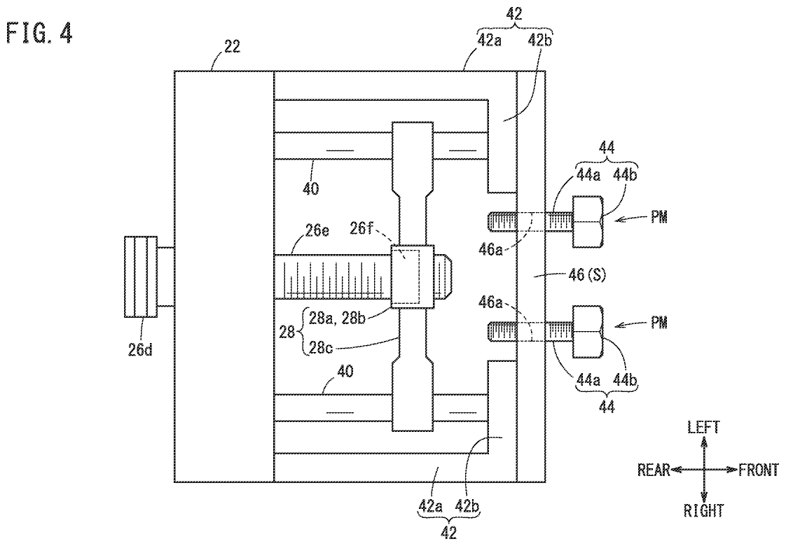

The injection molding machine 10 according to a first modification will be described. FIG. 4 is a top view showing a state in which the crosshead 28 is viewed from the upper toggle link 30 in the injection molding machine 10 according to the first modification. It should be noted that the same elements as those of the embodiment are denoted by the same reference numerals, and description thereof will be omitted.

The injection molding machine 10 according to the first modification includes a support member 46. The support member 46 functions as the support member S that supports the screw members 44 by being screwed with the screw members 44. That is, in this instance, the guide rod support 42 does not function as the support member S. The support member 46 is fixed to the guide rod supports 42. The support member 46 includes two internal threaded portions 46a (screw holes) that are screwed with the two screw members 44. In this manner, the crosshead pressing mechanisms PM may include, as the support member S, the support member 46 that is fixed to the guide rod supports 42 and does not directly contribute to supporting the guide rods 40. Since the first modification is substantially the same as the embodiment except for the above features, a detailed description thereof will be omitted.

### (Modification 2)

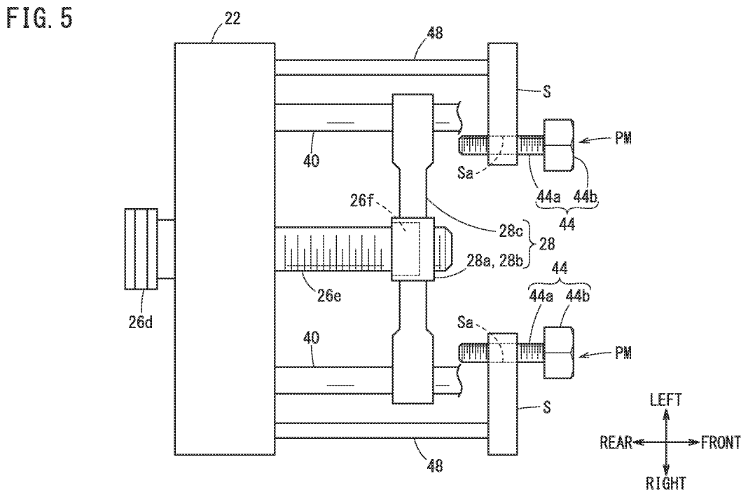

The injection molding machine 10 according to a second modification will be described. FIG. 5 is a top view showing a state in which the crosshead 28 is viewed from the upper toggle link 30 in the injection molding machine 10 according to the second modification. It should be noted that the same elements as those of the embodiment are denoted by the same reference numerals, and description thereof will be omitted.

The support member S of each of the crosshead pressing mechanisms PM according to the second modification is supported by a base member 48 that is fixed to the rear platen 22. The support member S includes an internal threaded portion Sa (screw hole) screwed with the screw member 44. The base member 48 is a member different from the guide rod support 42. In this manner, the crosshead pressing mechanisms PM may include the support members S which are not fixed to the guide rod supports 42. Since the second modification is substantially the same as the embodiment except for the above features, a detailed description thereof will be omitted.

### (Modification 3)

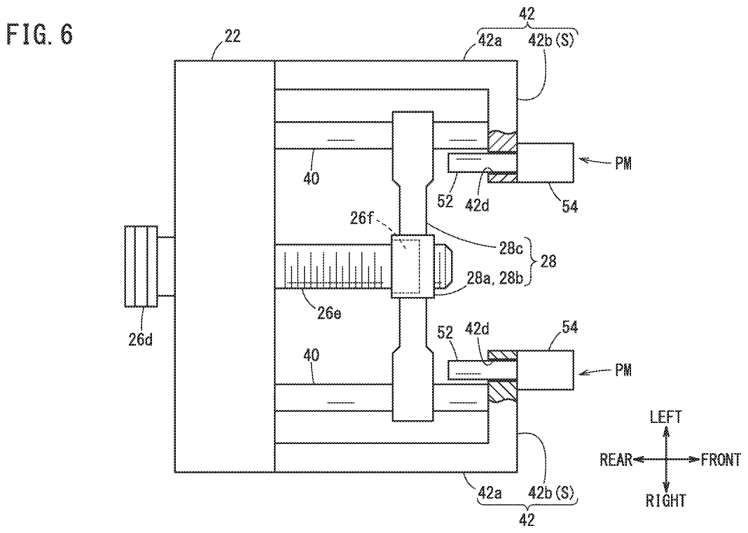

The injection molding machine 10 according to a third modification will be described. FIG. 6 is a top view showing a state in which the crosshead 28 is viewed from the upper toggle link 30 in the injection molding machine 10 according to the third modification. It should be noted that the same elements as those of the embodiment are denoted by the same reference numerals, and description thereof will be omitted.

The crosshead pressing mechanisms PM according to the third modification each include a rod 52, a drive unit 54, and the support member S (the support portion 42b). The rod 52 has a shape extending along the front-rear direction. The drive unit 54 is, for example, a linear motor or a hydraulic cylinder that moves the rod 52 along the front-rear direction. The support member S (the support portion 42b) supports the drive unit 54. The support member S includes a through hole 42d through which the rod 52 passes. The drive unit 54 may be a combination of a motor and a conversion mechanism that converts a rotational motion into a linear motion. In this manner, the crosshead pressing mechanisms PM may each include the drive unit 54. The drive unit 54 of the crosshead pressing mechanism PM outputs a force (axial force) required to release the lock-up state against the friction in the toggle link 30. Since the third modification is substantially the same as the embodiment except for the above features, a detailed description thereof will be omitted.

### (Other Modifications)

In the embodiment and the modifications described above, two crosshead pressing mechanisms PM are provided, but the number of the crosshead pressing mechanisms PM may be one, or three or more. The crosshead 28 can be pressed and moved backward by using one or three or more crosshead pressing mechanisms PM.

Further, the crosshead pressing mechanism PM is provided on the rear platen 22 in the embodiment and the modifications, but the crosshead pressing mechanism PM may be provided on another member, for example, the base 12.

In the third modification, the drive unit 54 is supported by the support portion 42b of the guide rod support 42, but may be supported by the support member 46 or the support member S shown in the first modification or the second modification.

### Modified Embodiment

The present invention is not limited to the above-described embodiment, and various configurations can be adopted therein without departing from the essence and gist of the present invention.

### Invention Obtained from Embodiment

The invention that can be grasped from the above-described embodiment and modifications will be described below.
[1] The mold clamping device (16) of the injection molding machine (10) includes: the stationary platen (20) configured to hold the fixed mold (14a); the rear platen (22); the plurality of tie bars (34) configured to connect the stationary platen and the rear platen; the movable platen (24) disposed between the stationary platen and the rear platen, and configured to hold the movable mold (14b) in a manner so that the movable mold and the fixed mold face each other, the movable platen being movable along the axial direction of each of the tie bars; the ball screw (26e) configured to be rotated by the motor (26a); the crosshead (28) disposed between the rear platen and the movable platen, and configured to be moved along the axial direction by rotation of the ball screw; the toggle link (30) configured to move the movable platen along the axial direction in accordance with movement of the crosshead; and the crosshead pressing mechanism (PM) configured to press the crosshead in order for the crosshead to move toward the rear platen. According to this feature, even in the case of failure of the motor or power failure, the crosshead can be pressed and moved toward the rear platen by the crosshead pressing mechanism. As a result, the movable platen can be moved to separate the movable mold from the fixed mold to release the clamping force.
[2] The crosshead pressing mechanism includes the screw member (44) extending along the axial direction, and the support member (S, 46, support portion 42b) configured to be screwed with the screw member to support the screw member, and the screw member presses the crosshead by rotating with respect to the support member. According to this feature, it is possible to press and move the crosshead by rotating the screw member.
[3] The crosshead pressing mechanism includes the rod (52) extending along the axial direction, the drive unit (54) configured to move the rod along the axial direction, and the support member (S, support portion 42b) configured to support the drive unit, and the rod presses the crosshead. According to this feature, the rod can press and move the crosshead by means of the drive unit.
[4] The support member is fixed to the rear platen. According to this feature, the crosshead can be pressed and moved by using the screw member or the drive unit held by the support member fixed to the rear platen.
[5] The guide rod (40) extending in the axial direction and configured to guide the crosshead is provided, and the support member supports the guide rod. According to this feature, the support member can support the guide rod and the screw member (or the drive unit).
[6] A plurality of the crosshead pressing mechanisms are provided so as to be symmetrical with respect to the ball screw in the width direction of the mold clamping device, the width direction being orthogonal to the axial direction. According to this feature, by using the plurality of crosshead pressing mechanisms that are symmetrical with respect to the ball screw, pressing forces that are symmetrical in the width direction can be applied to the crosshead.
[7] The crosshead pressing mechanism releases the lock-up state in which the toggle link is extended by the predetermined amount or more and the clamping force is generated between the fixed mold and the movable mold. According to this feature, the clamping force can be released to prevent the oil film breakage of the toggle mechanism from occurring and the toggle mechanism from being stuck.

1. A mold clamping device of an injection molding machine, the mold clamping device comprising:
a stationary platen configured to hold a fixed mold;
a rear platen;
a plurality of tie bars configured to connect the stationary platen and the rear platen;
a movable platen disposed between the stationary platen and the rear platen, and configured to hold a movable mold in a manner so that the movable mold and the fixed mold face each other, the movable platen being movable along an axial direction of each of the tie bars;
a ball screw configured to be rotated by a motor;
a crosshead disposed between the rear platen and the movable platen, and configured to be moved along the axial direction by rotation of the ball screw;
a toggle mechanism configured to move the movable platen along the axial direction in accordance with movement of the crosshead; and
a crosshead pressing mechanism configured to press the crosshead in order for the crosshead to move toward the rear platen.

2. The mold clamping device of the injection molding machine according to claim 1, wherein
the crosshead pressing mechanism includes a screw member extending along the axial direction, and a support member configured to be screwed with the screw member to support the screw member, and the screw member presses the crosshead by rotating with respect to the support member.

3. The mold clamping device of the injection molding machine according to claim 1, wherein
the crosshead pressing mechanism includes a rod extending along the axial direction, a drive unit configured to move the rod along the axial direction, and a support member configured to support the drive unit, and the rod presses the crosshead.

4. The mold clamping device of the injection molding machine according to claim 2, wherein
the support member is fixed to the rear platen.

5. The mold clamping device of the injection molding machine according to claim 4, further comprising
a guide rod extending in the axial direction and configured to guide the crosshead, wherein
the support member supports the guide rod.

6. The mold clamping device of the injection molding machine according to claim 1, wherein
a plurality of the crosshead pressing mechanisms are provided so as to be symmetrical with respect to the ball screw in a width direction of the mold clamping device, the width direction being orthogonal to the axial direction.

7. The mold clamping device of the injection molding machine according to claim 1, wherein
the crosshead pressing mechanism releases a lock-up state in which the toggle link mechanism is extended by a predetermined amount or more and a clamping force is generated between the fixed mold and the movable mold.
